(19) United States
(12) Patent Application Publication
(10) Pub. No.: US 2026/0149390 A1
(43) Pub. Date: May 28, 2026

(54) AUXILIARY RESONANT COMMUTATED POLE (ARCP) DEVICE AND OPERATING METHOD THEREOF

(71) Applicant: Industrial Technology Research Institute, Hsinchu (TW)

(72) Inventors: Chi-Chung Liao, Tainan City (TW); Yu Tsai, Kaohsiung City (TW); Yan-Fu Jhou, Tainan City (TW); Hung-Yi Teng, Kaohsiung City (TW)

(73) Assignee: Industrial Technology Research Institute, Hsinchu (TW)

(21) Appl. No.: 19/023,207

(22) Filed: Jan. 15, 2025

(30) Foreign Application Priority Data
Nov. 26, 2024 (TW) 113145487

(51) Int. Cl. H02M 7/48; H02H 1/00; H02H 7/122; H02M 1/32

(52) U.S. Cl. CPC H02M 7/4815; H02H 1/0007; H02H 7/122; H02M 1/32

(57) ABSTRACT

An auxiliary resonant commutated pole (ARCP) device and an operating method of the ARCP device are provided. The ARCP device includes a first resonant capacitor, a second resonant capacitor, a resonant element, a first voltage switch, a second voltage switch, and a controller. The first resonant capacitor is connected between a power terminal and a connection node. The second resonance capacitor is connected between the connection node and a reference voltage terminal. A first terminal of the resonant element is connected to the connection node. The first voltage switch is connected between the power terminal and a second terminal of the resonant element. The second voltage switch is connected between the second terminal of the resonant element and the reference voltage terminal. The controller controls the first voltage switch and the second voltage switch so that a voltage value at the connection node is within a set range.

### CROSS-REFERENCE TO RELATED APPLICATION

This application claims the priority benefit of Taiwan application serial no. 113145487, filed on Nov. 26, 2024. The entirety of the above-mentioned patent application is hereby incorporated by reference herein and made a part of this specification.

### TECHNICAL FIELD

The disclosure relates to a device and an operating method of the device, and in particular, to an auxiliary resonant commutated pole (ARCP) device and an operating method of the ARCP device.

### BACKGROUND

Auxiliary resonant commutated pole (ARCP) is suitable for use in the field of power electronics. ARCP may be used to improve the performance of power converters, especially to reduce switching losses of power converters and to increase efficiency of power converters. ARCP includes a first resonant capacitor and a second resonant capacitor. The first resonant capacitor is connected between a power terminal and a connection node. The second resonance capacitor is connected between the connection node and a reference voltage terminal. It should be noted that without limiting the voltage value at the connection node, the offset of the voltage value at the connection node increases ARCP and the power consumption of the power converter. Therefore, the voltage value located at the connection node needs to be limited.

### SUMMARY

The disclosure provides an auxiliary resonant commutated pole (ARCP) device and an operating method of the ARCP device that may limit the voltage value at a connection node to reduce power consumption.

In an embodiment of the disclosure, an ARCP device includes a first resonant capacitor, a second resonant capacitor, a resonant element, a first voltage switch, a second voltage switch, and a controller. The first resonant capacitor is connected between a power terminal and a connection node. The second resonance capacitor is connected between the connection node and a reference voltage terminal. A first terminal of the resonant element is connected to the connection node. The first voltage switch is connected between the power terminal and a second terminal of the resonant element. The second voltage switch is connected between the second terminal of the resonant element and the reference voltage terminal. The controller is connected to a control terminal of the first voltage switch and a control terminal of the second voltage switch. The controller controls a switching operation of the first voltage switch and the second voltage switch according to a voltage value at the connection node so that the voltage value at the connection node is within a set range.

In an embodiment of the disclosure, an operating method is applicable to an ARCP device. The ARCP device includes a first resonant capacitor, a second resonant capacitor, a resonant element, a first voltage switch, and a second voltage switch. The first resonant capacitor is connected between a power terminal and a connection node. The second resonance capacitor is connected between the connection node and a reference voltage terminal. A first terminal of the resonant element is connected to the connection node. The first voltage switch is connected between the power terminal and a second terminal of the resonant element. The second voltage switch is connected between the second terminal of the resonant element and the reference voltage terminal. The operating method includes: detecting a voltage value at a connection node; and turning on one of a first voltage switch and a second voltage switch when the voltage value at the connection node exceeds a set range so that the voltage value at the connection node is within the set range.

Based on the above, the ARCP device includes the first voltage switch and the second voltage switch. ARCP may use the switching operation of the first voltage switch and the second voltage switch to adjust the voltage value at the connection node within the set range. In this way, the ARCP device may limit the voltage value at the connection node to reduce power consumption.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram of an auxiliary resonant commutated pole (ARCP) device shown according to an embodiment of the disclosure.

FIG. 2 is a flowchart of an operating method shown according to an embodiment of the disclosure.

FIG. 3 is a flowchart of an operating method shown according to an embodiment of the disclosure.

FIG. 4 is a schematic diagram of an ARCP device shown according to an embodiment of the disclosure.

### DESCRIPTION OF THE EMBODIMENTS

A portion of the embodiments of the disclosure is described in detail hereinafter with reference to figures. In the following, the same reference numerals in different figures should be considered to represent the same or similar elements. The embodiments are a part of the disclosure, and do not disclose all possible implementation modes of the disclosure. Rather, the embodiments are merely examples within the claims of the disclosure.

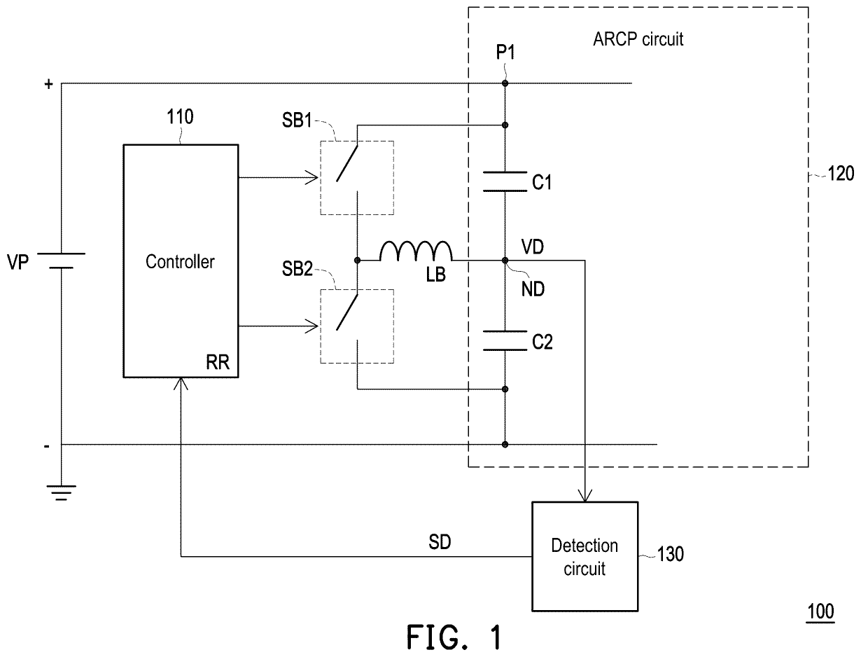

Please refer to FIG. 1. FIG. 1 is a schematic diagram of an auxiliary resonant commutated pole (ARCP) device shown according to an embodiment of the disclosure. In the present embodiment, an ARCP device 100 includes resonant capacitors C1 and C2, a resonant element LB, a first voltage switch SB1, a second voltage switch SB2, and a controller 110. The resonant capacitors C1 and C2 are disposed in an ARCP circuit 120, for example. The resonant capacitor C1 is connected between a power terminal P1 and a connection node ND. The resonance capacitor C2 is connected between the connection node ND and a reference voltage terminal (such as ground). The first terminal of the resonant element LB is connected to the connection node ND. The first voltage switch SB1 is connected between the power terminal P1 and the second terminal of the resonant element LB. The second voltage switch SB2 is connected between the second terminal of the resonant element LB and the reference voltage terminal.

In the present embodiment, the controller 110 is connected to the control terminal of the first voltage switch SB1 and the control terminal of the second voltage switch SB2. The controller 110 controls the switching operation of the first voltage switch SB1 and the second voltage switch SB2 according to a voltage value VD at the connection node ND so that the voltage value VD at the connection node ND is within a set range RR.

It should be mentioned that, in the ARCP device 100, via the switching operation of the first voltage switch SB1 and the second voltage switch SB2, the voltage value VD at the connection node ND may be within the set range RR. In this way, the ARCP device 100 may limit the voltage value VD at the connection node ND to reduce power consumption. In addition, the voltage value VD at the connection node ND is limited within the set range RR. Therefore, the ripple at the connection node ND may also be limited within the set range RR.

In the present embodiment, when the voltage value VD at the connection node ND exceeds the set range RR, the controller 110 turns on one of the first voltage switch SB1 and the second voltage switch SB2. When the voltage value VD at the connection node ND is within the set range RR, the controller 110 turns off the first voltage switch SB1 and the second voltage switch SB2.

The voltage value VD of the connection node ND determines the power consumption of the ARCP device 100. For example, the voltage value VD of the connection node ND is the balance voltage between the resonant capacitors C1 and C2. There is a power supply voltage value VP between the power terminal P1 and the reference voltage terminal. Therefore, the set range RR may be set to ±a% of the intermediate value of the power supply voltage value VP (i.e., VP/2±a%). For example, a is equal to “5”, but the disclosure is not limited to the value of a (a may be a real number). Therefore, the set range RR is between 0.475 times the power supply voltage value VP and 0.525 times the power supply voltage value VP. When the voltage value VD at the connection node ND exceeds the range of 0.475 times the power supply voltage value VP to 0.525 times the power supply voltage value VP, the controller 110 turns on one of the first voltage switch SB1 and the second voltage switch SB2. When the voltage value VD at the connection node ND is within the range of 0.475 times the power supply voltage value VP to 0.525 times the power supply voltage value VP, the controller 110 turns off the first voltage switch SB1 and the second voltage switch SB2.

In the present embodiment, the ARCP device 100 further includes a detection circuit 130. The detection circuit 130 is connected to the connection node ND and the controller 110. The detection circuit 130 receives the voltage value VD at the connection node ND to generate a detection signal SD, and provides the detection signal SD to the controller 110. The controller 110 determines whether the voltage value VD at the connection node ND is within the set range RR according to the detection signal SD. In the present embodiment, the detection signal SD may be a digital signal, an analog voltage signal, an analog current signal, or an encoded signal.

In the present embodiment, the first voltage switch SB1 and the second voltage switch SB2 are respectively implemented by a transistor. For example, the first voltage switch SB1 and the second voltage switch SB2 are respectively implemented by a metal-oxide-semiconductor field-effect transistor (MOSFET), an insulated gate bipolar transistor (IGBT), a silicon carbide MOSFET, or a gallium nitride (GaN) FET, but are not limited thereto.

In the present embodiment, the resonant element LB is implemented by an inductor. The resonant element LB may be used to limit the current flowing through the first voltage switch SB1 and the second voltage switch SB2. Therefore, the resonant element LB may reduce the power consumption of the first voltage switch SB1 and the second voltage switch SB2. The resonant element LB may increase the lifespan of the first voltage switch SB1 and the second voltage switch SB2.

In the present embodiment, the higher the inductance of the resonant element LB, the lower the current value of the current flowing through the first voltage switch SB1 and the current value of the current flowing through the second voltage switch SB2. The lower the inductance of the resonant element LB, the higher the current value of the current flowing through the first voltage switch SB1 and the current value of the current flowing through the second voltage switch SB2.

In the present embodiment, the controller 110 is, for example, a central processing unit (CPU), or other programmable general-purpose or special-purpose microprocessors, digital signal processors (DSPs), programmable controllers, application-specific integrated circuits (ASICs), programmable logic devices (PLDs), or other similar devices, or a combination of the devices.

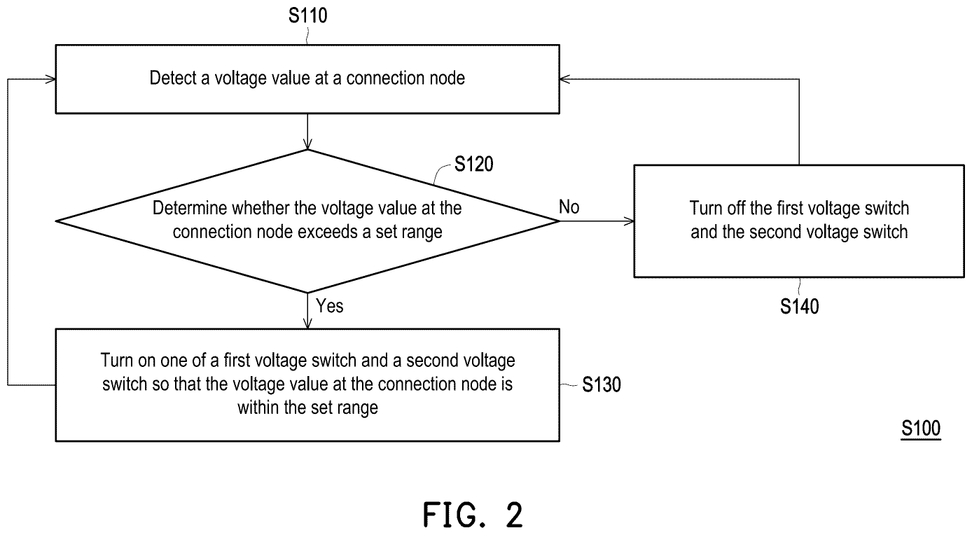

Please refer to FIG. 1 and FIG. 2. FIG. 2 is a flowchart of an operating method shown according to an embodiment of the disclosure. In the present embodiment, an operating method S100 is applicable to the ARCP device 100. The operating method S100 includes steps S110 to S140. In step S110, the voltage value VD at the connection node ND is detected. In step S120, the controller 110 determines whether the voltage value VD of the connection node ND exceeds the set range RR. Furthermore, the controller 110 may determine whether the voltage value VD at the connection node ND exceeds the set range RR according to the detection signal SD.

For example, the set range RR is between 0.475 times the power supply voltage value VP and 0.525 times the power supply voltage value VP, but the disclosure is not limited thereto.

When the voltage value VD at the connection node ND exceeds the set range RR, in step S130, the controller 110 turns on one of the first voltage switch SB1 and the second voltage switch SB2 so that the voltage value VD at the connection node ND is within the set range RR. Next, the operating method S100 returns to the operation of step S110.

Moreover, when the voltage value VD at the connection node ND is within the set range RR, the controller 110 turns off the first voltage switch SB1 and the second voltage switch SB2 in step S140. Next, the operating method S100 returns to the operation of step S110.

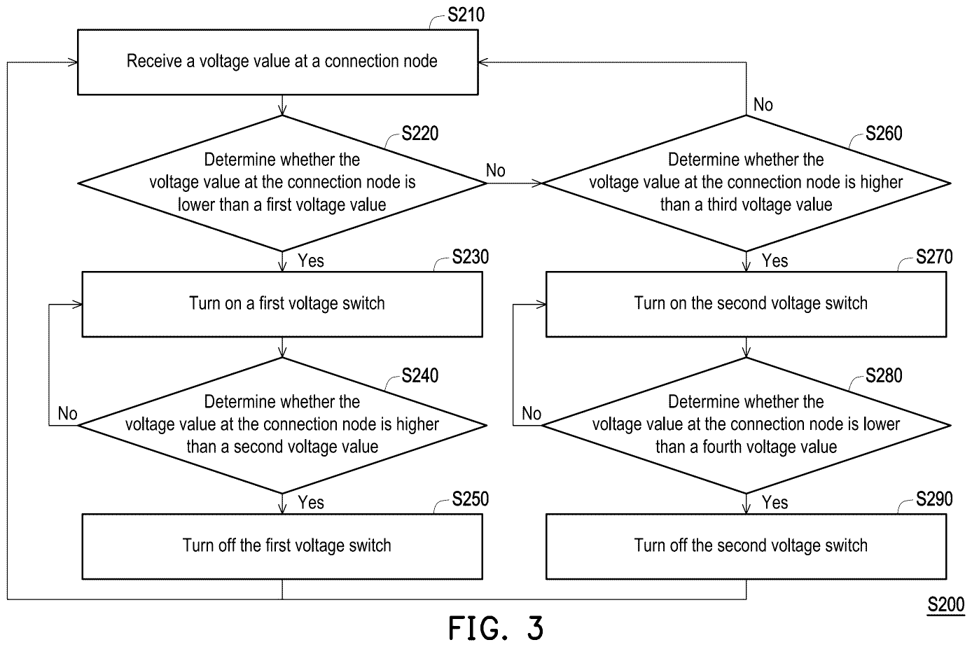

Please refer to FIG. 1 and FIG. 3. FIG. 3 is a flowchart of an operating method shown according to an embodiment of the disclosure. In the present embodiment, an operating method S200 is applicable to the ARCP device 100. The operating method S200 includes steps S210 to S290. In step S210, the voltage value VD at the connection node ND is received. In step S220, the controller 110 determines whether the voltage value VD at the connection node ND is lower than the first voltage value according to the detection signal SD. The first voltage value is the lowest voltage value of the set range RR. The first voltage value is, for example, 0.475 times the power supply voltage value VP, but the disclosure is not limited thereto. When the voltage value VD at the connection node ND is lower than the first voltage value (e.g., 0.475 times the power supply voltage value VP), the voltage value VD at the connection node ND is too low and exceeds the set range RR. Therefore, the controller 110 turns on the first voltage switch SB1 in step S230. Moreover, the second voltage switch SB2 is turned off. When the first voltage switch SB1 is turned on and the second voltage switch SB2 is turned off, the power supply voltage value VP charges the connection node ND. Therefore, the voltage value VD at the connection node ND is increased.

In step S240, the controller 110 determines whether the voltage value VD at the connection node ND is higher than the second voltage value according to the detection signal SD. The second voltage value is an intermediate value higher than the first voltage value and lower than the power supply voltage value VP (i.e., VP/2). The second voltage value is, for example, 0.4875 times the power supply voltage value VP, but the disclosure is not limited thereto. When the voltage value VD at the connection node ND is lower than or equal to the second voltage value (e.g., 0.4875 times the power supply voltage value VP), the controller 110 continues to turn on the first voltage switch SB1 in step S230.

Moreover, when the voltage value VD at the connection node ND is higher than the second voltage value, the controller 110 turns off the first voltage switch SB1 in step S250. That is, when the voltage value VD at the connection node ND rises higher than the second voltage value, the controller 110 turns off the first voltage switch SB1. Next, the operating method S200 returns to the operation of step S210.

In step S220, when the voltage value VD located at the connection node ND is higher than or equal to the first voltage value, the controller 110 determines in step S260 whether the voltage value VD at the connection node ND is higher than a third voltage value (e.g., 0.525 times the power supply voltage value VP). The third voltage value is the highest voltage value of the set range RR. When the voltage value VD at the connection node ND is lower than or equal to the third voltage value, based on the determination in steps S220 and S260, the voltage value VD at the connection node ND is within the set range RR. Therefore, the operating method S200 returns to the operation of step S210.

Moreover, when the voltage value VD at the connection node ND is higher than the third voltage value, the voltage value VD at the connection node ND is too high and exceeds the set range RR. Therefore, the controller 110 turns on the second voltage switch SB2 in step S270. Moreover, the first voltage switch SB1 is turned off. When the second voltage switch SB2 is turned on and the first voltage switch SB1 is turned off, the voltage value VD at the connection node ND is pulled down.

In step S280, the controller 110 determines whether the voltage value VD at the connection node ND is lower than a fourth voltage value according to the detection signal SD. The fourth voltage value is higher than the intermediate value of the power supply voltage value VP and lower than the third voltage value. The fourth voltage value is, for example, 0.5125 times the power supply voltage value VP, but the disclosure is not limited thereto. When the voltage value VD at the connection node ND is higher than or equal to the fourth voltage value (e.g., 0.5125 times the power supply voltage value VP), the controller 110 continues to turn on the second voltage switch SB2 in step S270.

Moreover, when the voltage value VD at the connection node ND is lower than the fourth voltage value, the controller 110 turns off the second voltage switch SB2 in step S290. That is, when the voltage value VD at the connection node ND drops below the fourth voltage value, the controller 110 turns off the second voltage switch SB2. Next, the operating method S200 returns to the operation of step S210.

In the present embodiment, based on actual requirements, the first voltage value, the second voltage value, the third voltage value, and the fourth voltage value may be adjusted.

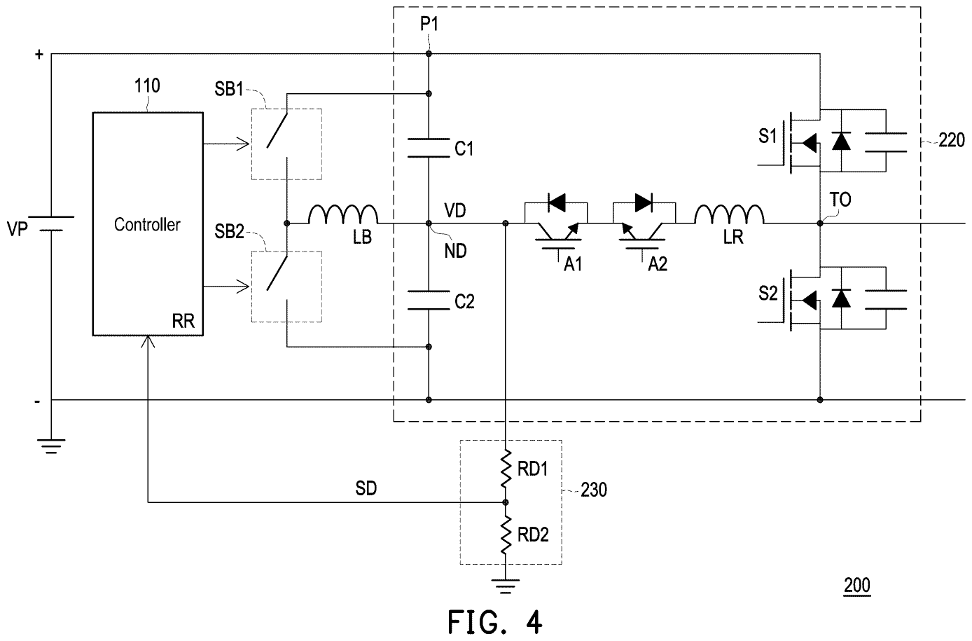

Please refer to FIG. 4. FIG. 4 is a schematic diagram of an ARCP device shown according to an embodiment of the disclosure. In the present embodiment, an ARCP device 200 includes the resonant element LB, the first voltage switch SB1, the second voltage switch SB2, the controller 110, an ARCP circuit 220, and a detection circuit 230. The ARCP circuit 220 includes the resonant capacitors C1 and C2, power switches S1 and S2, an inductor LR, and auxiliary switches A1 and A2. The resonant capacitor C1 is connected between the power terminal P1 and the connection node ND. The resonance capacitor C2 is connected between the connection node ND and a reference voltage terminal (such as ground). The first terminal of the power switch S1 is connected to the power terminal P1. The second terminal of the power switch S1 is connected to an output terminal TO of the ARCP device 200. The first terminal of the power switch S2 is connected to an output terminal TO of the ARCP device 200. The second terminal of the power switch S2 is connected to the reference voltage terminal. The auxiliary switches A1 and A2 and the inductor LR are connected in series between the connection node ND and the output terminal TO of the ARCP device 200.

In the present embodiment, the resonant capacitor C1 is connected between the power terminal P1 and the connection node ND. The resonance capacitor C2 is connected between the connection node ND and a reference voltage terminal. The first terminal of the resonant element LB is connected to the connection node ND. The first voltage switch SB1 is connected between the power terminal P1 and the second terminal of the resonant element LB. The second voltage switch SB2 is connected between the second terminal of the resonant element LB and the reference voltage terminal. The controller 110 controls the switching operation of the first voltage switch SB1 and the second voltage switch SB2.

In the present embodiment, the detection circuit 230 includes resistors RD1 and RD2. The first terminal of the resistor RD1 is connected to the connection node ND. The second terminal of the resistor RD1 is connected to the controller 110. The first terminal of resistor RD2 is connected to the second terminal of the resistor RD1. The second terminal of the resistor S2 is connected to the reference voltage terminal. The second terminal of the resistor RD1 outputs the detection signal SD. Therefore, the detection signal SD is a divided voltage signal of the voltage value VD at the connection node ND.

In the present embodiment, the ARCP device 200 may be operated based on the operating method S100 shown in FIG. 2 and the operating method S200 shown in FIG. 3.

In the present embodiment, based on the configuration of the ARCP circuit 220, if the voltage value VD at the connection node ND is controlled within the range (i.e., the set range RR) of ±5% of the intermediate value of the power supply voltage value VP, the power consumption at the power switches S1 and S2 is balanced. Moreover, if the voltage value VD at the connection node ND is outside the set range RR, the power consumption of one of the power switches S1 and S2 is increased significantly. Therefore, the power consumption of the ARCP device 200 is increased. In other words, if the voltage value VD at the connection node ND may be controlled within the set range RR, the power consumption of the ARCP device 200 is reduced. After testing, if the voltage value VD at the connection node ND may be controlled within the set range RR, the total power consumption of the ARCP device 200 may be reduced by 5.3% compared to the current ARCP device (i.e., the ARCP circuit 220). Compared with the current ARCP device, the power consumption of the power switches S1 and S2 of the ARCP device 200 may be reduced by 19%.

In addition, the voltage value VD at the connection node ND is limited within the set range RR. Therefore, the ripple at the connection node ND may also be limited within the set range RR. For example, the power supply voltage value VP is equal to 800 volts. Therefore, the voltage value VD at the connection node ND is controlled at 400±20 volts. Therefore, the amplitude of the ripple at the connection node ND is limited to 40 volts.

Based on the above, in the ARCP device 100, via the switching operation of the first voltage switch and the second voltage switch, the voltage value at the connection node may be within the set range. In this way, the ARCP device may limit the voltage value at the connection node to reduce power consumption. In addition, the voltage value at the connection node is limited within the set range. Therefore, the ripple at the connection node may also be limited within the set range.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An auxiliary resonant commutated pole device, comprising:
a first resonant capacitor connected between a power terminal and a connection node;
a second resonance capacitor connected between the connection node and a reference voltage terminal;
a resonant element, wherein a first terminal of the resonant element is connected to the connection node;
a first voltage switch connected between the power terminal and a second terminal of the resonant element;
a second voltage switch connected between a second terminal of the resonant element and the reference voltage terminal; and
a controller connected to a control terminal of the first voltage switch and a control terminal of the second voltage switch and configured to control a switching operation of the first voltage switch and the second voltage switch according to a voltage value at the connection node so that the voltage value at the connection node is within a set range.

2. The auxiliary resonant commutated pole device of claim 1, wherein when the voltage value at the connection node exceeds the set range, the controller turns on one of the first voltage switch and the second voltage switch.

3. The auxiliary resonant commutated pole device of claim 1, wherein when the voltage value at the connection node is within the set range, the controller turns off the first voltage switch and the second voltage switch.

4. The auxiliary resonant commutated pole device of claim 1, wherein:
there is a power supply voltage value between the power terminal and the reference voltage terminal,
the set range is between ±a% of an intermediate value of the power supply voltage value, and
a is a real number.

5. The auxiliary resonant commutated pole device of claim 4, wherein:
when the voltage value at the connection node is lower than a first voltage value, the controller turns on the first voltage switch, and
the first voltage value is a lowest voltage value of the set range.

6. The auxiliary resonant commutated pole device of claim 5, wherein:
when the voltage value at the connection node rises higher than a second voltage value, the controller turns off the first voltage switch, and
the second voltage value is higher than the first voltage value and lower than the intermediate value.

7. The auxiliary resonant commutated pole device of claim 4, wherein:
when the voltage value at the connection node is higher than a third voltage value, the controller turns on the second voltage switch, and
the third voltage value is a highest voltage value of the set range.

8. The auxiliary resonant commutated pole device of claim 7, wherein:
when the voltage value at the connection node drops to a fourth voltage value, the controller turns off the second voltage switch, and
the fourth voltage value is higher than the intermediate value and lower than the third voltage value.

9. The auxiliary resonant commutated pole device of claim 1, wherein the resonant element is implemented by an inductor.

10. The auxiliary resonant commutated pole device of claim 1, further comprising:
a detection circuit connected to the connection node and the controller, configured to receive a voltage value at the connection node to generate a detection signal, and provide the detection signal to the controller,
wherein the controller determines whether the voltage value at the connection node is within the set range according to the detection signal.

11. The auxiliary resonant commutated pole device of claim 10, wherein the detection circuit comprises:
a first resistor, wherein a first terminal of the first resistor is connected to the connection node, and a second terminal of the first resistor is connected to the controller; and
a second resistor, wherein a first terminal of the second resistor is connected to the second terminal of the first resistor, and a second terminal of the second resistor is connected to the reference voltage terminal.

12. The auxiliary resonant commutated pole device of claim 11, wherein the second terminal of the first resistor outputs the detection signal.

13. An operating method for an auxiliary resonant commutated pole device, wherein the auxiliary resonant commutated pole device comprises a first resonant capacitor, a second resonant capacitor, a resonant element, a first voltage switch, and a second voltage switch, the first resonant capacitor is connected between a power supply terminal and a connection node, the second resonant capacitor is connected between the connection node and a reference voltage terminal, a first terminal of the resonant element is connected to the connection node, the first voltage switch is connected between a power terminal and a second terminal of the resonant element, the second voltage switch is connected between the second terminal of the resonant element and the reference voltage terminal, and the operating method comprises:
detecting a voltage value at the connection node; and
turning on one of the first voltage switch and the second voltage switch when the voltage value at the connection node exceeds a set range so that the voltage value at the connection node is within the set range.

14. The operating method of claim 13, further comprising:
turning off the first voltage switch and the second voltage switch when the voltage value at the connection node is within the set range.

15. The operating method of claim 13, wherein:
there is a power supply voltage value between the power terminal and the reference voltage terminal,
the set range is between ±a% of an intermediate value of the power supply voltage value, and
a is a real number.

16. The operating method of claim 15, wherein the step of turning on one of the first voltage switch and the second voltage switch when the voltage value at the connection node exceeds the set range so that the voltage value at the connection node is within the set range comprises:
turning on the first voltage switch when the voltage value at the connection node is lower than a first voltage value,
wherein the first voltage value is a lowest voltage value of the set range.

17. The operating method of claim 16, further comprising:
turning off the first voltage switch when the voltage value at the connection node rises higher than a second voltage value,
wherein the second voltage value is higher than the first voltage value and lower than the intermediate value.

18. The operating method of claim 15, wherein the step of turning on one of the first voltage switch and the second voltage switch when the voltage value at the connection node exceeds the set range so that the voltage value at the connection node is within the set range comprises:
turning on the second voltage switch when the voltage value at the connection node is higher than a third voltage value,
wherein the third voltage value is a highest voltage value of the set range.

19. The operating method of claim 18, further comprising:
turning off the second voltage switch when the voltage value at the connection node drops to a fourth voltage value,
wherein the fourth voltage value is higher than the intermediate value and lower than the third voltage value.

20. The operating method of claim 13, wherein the resonant element is implemented by an inductor.

21. The operating method of claim 13, wherein the step of detecting the voltage value at the connection node comprises:
receiving the voltage value at the connection node via a detection circuit to generate a detection signal; and
determining whether the voltage value at the connection node is within the set range according to the detection signal.

22. The operating method of claim 21, wherein the detection circuit comprises:
a first resistor, wherein a first terminal of the first resistor is connected to the connection node; and
a second resistor, wherein a first terminal of the second resistor is connected to a second terminal of the first resistor, and a second terminal of the second resistor is connected to the reference voltage terminal.

23. The operating method of claim 22, wherein the step of receiving the voltage value at the connection node via the detection circuit to generate the detection signal comprises:
outputting the detection signal via the second terminal of the first resistor.
